(19) United States
(12) Patent Application Publication
(10) Pub. No.: US 2021/0394780 A1
(43) Pub. Date: Dec. 23, 2021

(54) FLEXIBLE MODULAR PLATFORM

(71) Applicant: Ford Global Technologies, LLC, Dearborn, MI (US)

(72) Inventors: Galen Keith Thomas, Dearborn, MI (US); Kerry Lance Paskell, Detroit, MI (US)

(73) Assignee: Ford Global Technologies, LLC, Dearborn, MI (US)

(21) Appl. No.: 17/165,460

(22) Filed: Feb. 2, 2021

Related U.S. Application Data
(63) Continuation-in-part of application No. 16/909,462, filed on Jun. 23, 2020.

(51) Int. Cl. B60W 60/00; B62D 21/02; B60W 10/20; B60K 1/04; B60W 30/14; B60W 10/08; B60W 30/095; G05D 1/00

(52) U.S. Cl. CPC B60W 60/001; B62D 21/02; B60W 10/20; B60K 1/04; B60W 30/143; B60W 10/08; B60W 2420/42; G05D 1/0016; B60W 60/007; B60W 2510/244; B60W 2520/10; B60W 2555/20; B60W 2556/45; B60W 30/0956

(57) ABSTRACT

A modular vehicle subassembly includes a frame assembly with wheels and a steering system configured to steer at least one of the wheels and change a course of direction of the frame assembly. A propulsion system configured to drive at least one of the wheels and move the frame assembly in at least one of a forward direction and a backward direction is included. At least one transient data sensor, an onboard controller, and an onboard communications link are included and the least one transient data sensor is coupled is configured to detect and transmit transient data. The onboard controller is configured to receive the transient data from the at least one transient data sensor, direct the steering system and the propulsion system such that the frame assembly moves along a predefined path through a flexible modular platform facility.

### CROSS-REFERENCE TO RELATED APPLICATIONS

This application claims the benefit of and is a continuation-in-part of U.S. patent application Ser. No. 16/909,462 filed on Jun. 23, 2020, which is commonly assigned with the present application. This application is also related to co-pending applications filed concurrently herewith titled “METHOD OF VEHICLE ASSEMBLY INCLUDING MODULAR VEHICLE SUBASSEMBLY CONTROLS, COMMUNICATION AND MANUFACTURE”, “FACILITY SENSORY SYSTEM FOR MONITORING, GUIDING, AND PROTECTING FLEXIBLE MODULAR PLATFORMS MOVING THROUGH AN ASSEMBLY LINE”, “FLEXIBLE MODULAR PLATFORM PLANT NAVIGATION SYSTEM”, and “METHOD OF STORING, PROCESSING, AND TRANSMITTING DIGITAL TWINS FOR FLEXIBLE MODULE PLATFORMS AND VEHICLES”, which are commonly assigned with the present application. The contents of these applications are incorporated herein by reference in their entireties.

### FIELD

The present disclosure relates to vehicles and manufacturing of vehicles.

### BACKGROUND

The statements in this section merely provide background information related to the present disclosure and may not constitute prior art.

Vehicles are typically manufactured in assembly plants designed and built to support a projected vehicle assembly volume based on mechanical infrastructure requirements needed to support manufacturing operations. And such mechanical infrastructure requirements typically include conveyer systems and/or automatic guided vehicle (AGV) based systems to move vehicle subassemblies from station to station along an assembly line. However, the time, investment and capital expenditure needed to build conveyer systems or to adapt AGVs for specific application tasks can be prohibitive.

These issues associated with moving vehicle subassemblies along assembly lines in vehicle assembly plants, among other issues related to manufacturing different product configurations in the same assembly facility, are addressed by the present disclosure.

### SUMMARY

This section provides a general summary of the disclosure and is not a comprehensive disclosure of its full scope or all of its features.

In one form of the present disclosure, a modular vehicle subassembly includes a frame assembly with a vehicle frame, wheels mounted on the vehicle frame, and a steering system configured to steer at least one of the wheels and change a course of direction of the frame assembly. A propulsion system configured to drive at least one of the wheels and move the frame assembly in at least one of a forward direction and a backward direction is included and coupled to the frame assembly. At least one transient data sensor, an onboard controller, and an onboard communications link are included. The at least one transient data sensor is coupled to the frame assembly and configured to detect and transmit transient data. Also, the onboard controller and the onboard communications link are coupled to the frame assembly and the onboard controller is configured to receive the transient data from the at least one transient data sensor, direct the steering system, and direct the propulsion system such that the frame assembly moves along a predefined path through a flexible modular platform facility.

In some variations, the wheels include two front wheels and two rear wheels, and the steering system is configured to steer the two front wheels.

In at least one variation the propulsion system includes an electric power propulsion system with at least one electric battery, at least one electric motor, and a drivetrain.

In some variations, the at least one transient data sensor includes at least one of a proximity sensor, a visual sensor, a speed sensor, a fluid level sensor, and a battery charge sensor.

In at least one variation the transient data is at least one of a status of one or more systems assembled on the frame assembly, a current assembly state of the one or more systems assembled on the frame assembly, and a position of one or more parts assembled on the frame assembly. In such variations the status of the one or more systems assembled on the frame assembly comprises at least one of a battery charge level, a tire pressure, a fluid level, and a fluid pressure.

In some variations, the onboard controller is coupled to the frame assembly and configured to execute at least one of a speed command, a stop movement command, a start movement command, a steer command, and an emergency stop command. In at least one variation, the at least one transient data sensor is releasably attached to the frame assembly and configured to be releasably attached to another frame assembly. Also, the at least one transient data sensor can be configured to detect at least one of a location of the frame assembly within a flexible modular platform facility, a position of the frame assembly within the flexible modular platform facility, a movement of the frame assembly within the flexible modular platform facility, an obstacle along a path of the frame assembly within the flexible modular platform facility, and an environmental condition of the frame assembly within the flexible modular platform facility. In some variations the onboard controller is configured to direct the frame assembly to move autonomously through a flexible modular platform facility.

In some variations, the onboard controller and the onboard communications link are coupled to the frame assembly. In such variations the onboard controller is configured to receive the transient data from the at least one transient data sensor and transmit onboard data to the onboard communications link, and the onboard communications link is configured to receive the onboard data from the onboard controller, transmit the onboard date to an external controller, receive offboard data from the external controller, and transmit the offboard data to the onboard controller. And in at least one variation the offboard data is at least one command for the onboard controller to execute. In some variations, the onboard controller is configured to direct the frame assembly to move via remote control through a flexible modular platform facility while in other variations the onboard controller is configured to direct the frame assembly to move autonomously through a flexible modular platform facility.

In another form of the present disclosure, a modular vehicle subassembly includes a frame assembly with a vehicle frame, wheels mounted to the vehicle frame, a steering system coupled to and configured to steer at least one of the wheels and change a course of direction of the vehicle subassembly, and a propulsion system comprising at least one electric battery, at least one electric motor, and a drivetrain. The propulsion system is configured to drive at least one of the wheels and move the frame assembly in at least one of a forward direction and a backward direction. An onboard communications link, a plurality of transient data sensors, and an onboard controller are included. The onboard communications link is configured to receive the offboard data from an external controller and transmit the offboard data to the onboard controller. The plurality of transient data sensors are coupled to the frame assembly and configured to detect and transmit transient data. And the onboard controller is configured to receive the transient data from the at least one transient data sensor, transmit onboard data to the onboard communications link, receive the offboard data from the onboard communications link, and direct the propulsion system and the steering system such that the frame assembly moves along a predefined path through a flexible modular platform facility.

In some variations, the plurality of transient data sensors include at least one of a proximity sensor, a visual sensor, a speed sensor, a fluid level sensor, and a battery charge sensor.

In at least one variation the transient data is at least one of a status of one or more systems assembled on the frame assembly, a current assembly state of the one or more systems assembled on the frame assembly, and a position of one or more parts assembled on the frame assembly.

In still another form of the present disclosure, a modular vehicle subassembly for remote control or autonomous movement through a flexible modular platform facility includes a frame assembly with a vehicle frame, wheels mounted to the vehicle frame, a steering system coupled to and configured to steer at least one of the wheels and change a course of direction of the vehicle subassembly, and a propulsion system comprising at least one electric battery, at least one electric motor, and a drivetrain. The propulsion system is configured to drive at least one of the wheels and move the frame assembly in at least one of a forward direction and a backward direction. A plurality of transient data sensors, an onboard controller and an onboard communications link are include and the onboard communications link is configured to receive offboard data from an external controller and transmit the offboard data to the onboard controller. The plurality of transient data sensors are coupled to the frame assembly and configured to detect and transmit transient data. And the onboard controller is configured to receive the transient data from the at least one transient data sensor, transmit onboard data to the onboard communications link, receive the offboard data from the onboard communications link, and direct the propulsion system and the steering system such that the frame assembly moves along a predefined path through a flexible modular platform facility.

In some variations, the plurality of transient data sensors comprise at least one of a proximity sensor, a visual sensor, a speed sensor, a fluid level sensor, and a battery charge sensor.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of modular vehicle subassembly according to the teachings of the present disclosure;

FIG. 2 is a top view of the modular vehicle subassembly in FIG. 2;

FIG. 3 is a block diagram of a remote controlled modular vehicle subassembly according to the teachings of the present disclosure;

FIG. 4 shows a remote controlled modular vehicle subassembly moving through assembly zones of a top hat assembly line according to the teachings of the present disclosure;

FIG. 5 is a block diagram of an autonomous modular vehicle subassembly according to the teachings of the present disclosure; and

FIG. 6 shows a plurality of autonomous modular vehicle subassemblies moving through assembly zones of a top hat assembly line according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

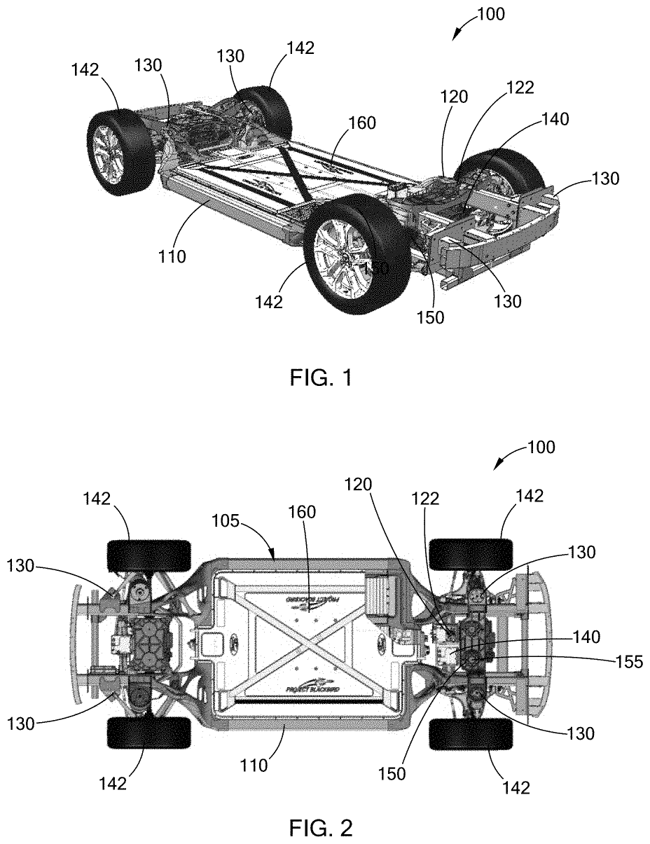

Referring to FIGS. 1 and 2, a modular vehicle subassembly (MVS) 100 (also known as a “flexible modular platform”) according to the teachings of the present disclosure is shown. The MVS 100 includes a frame assembly 105 with a vehicle frame 110, an onboard controller 120, transient data sensors 130, a drive system 140, wheels 142 mounted on the vehicle frame 110, a steering system 150, a braking system 155, and a propulsion system 160. In some variations, an onboard communications link 122 is included. As used herein, the phrase “communication link” refers to a communication channel that connects two or more devices for the purpose of data transmission. In at least one variation the onboard communications link 122 is a wireless communications link with a wireless signal receiver/transmitter that includes an antenna. In some variations, the MVS 100 is for an electric or hybrid vehicle and the propulsion system 160 includes one or more charged batteries that provides energy to the onboard controller 120, transient data sensors 130, drive system 140, steering system 150, and braking system 155.

The MVS 100, and other MVSs disclosed herein, is manufactured at a vehicle assembly facility and is self-transportable. That is, the MVS 100 is configured to move using its own power and steering through the same vehicle assembly facility where it was manufactured and/or through a separate vehicle assembly facility where additional assembly operations occur. For example, a plurality of MVSs 100 (also referred to herein simply as “MVSs 100”) can be wireless tethered together and/or wirelessly tethered to an assembly line infrastructure and thereby move under remote or autonomous control using their own power and steering along a predefined path prior through one or more assembly zones as discussed in greater detail below.

In some variations of the present disclosure the one or more assembly zones are part of a vehicle assembly facility that assembles a “top hat” onto the MVSs 100. As used herein the term phrase “assembly zone” refers to area, station or region of an assembly line where a predetermined number of components or parts are assembled onto a MVS 100 moving along the assembly line. And as used herein the phrase “top hat” refers to one or more vehicle upper body structures that can share a common platform (i.e., a common MVS 100). For example, the upper body structures can vary from a crossover vehicle to a sedan vehicle to a coupe vehicle. Accordingly, vehicle assembly facilities that assembly different vehicle upper body structures onto a common MVS 100 enhance economies of scale and product differentiation and are included within the teachings of the present disclosure.

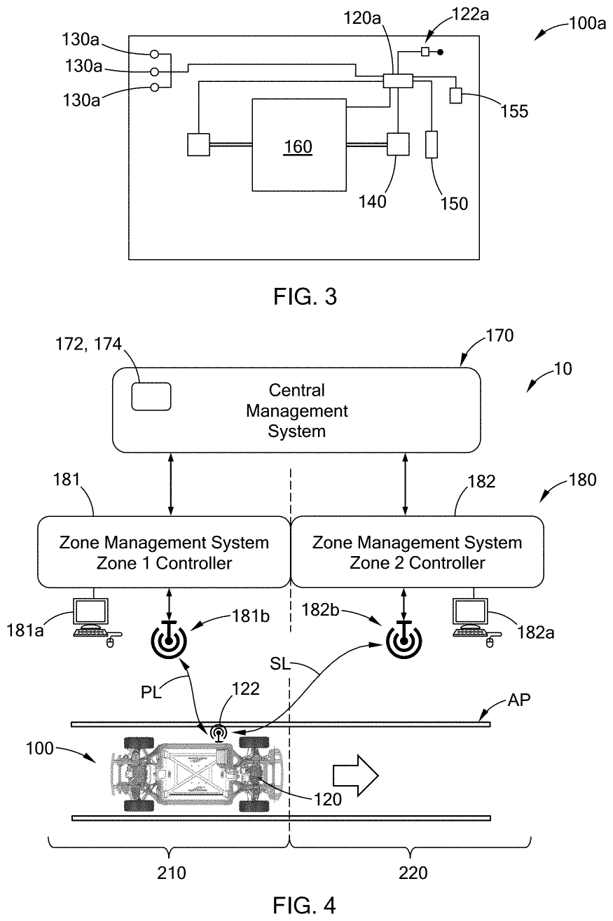

Referring to FIG. 3, an example functional block diagram of a MVS 100a according to one form of the present disclosure and configured for remote control movement is shown. As used herein, the phrase “remote control” refers to movement of a MVS 100 via commands and/or instruction from a controller not on the MVS 100 (i.e., an external controller). The MVS 100a includes an onboard controller 120a, an onboard communications link 122a, transient data sensors 130a, the drive system 140, the steering system 150, the braking system 155, and the propulsion system 160. The onboard controller 120a is in communication with the onboard communications link 122a, transient data sensors 130a, drive system 140, steering system 150, braking system 155, and propulsion system 160.

The onboard communications link 122a and the transient data sensors 130a are configured to transmit at least one of signals, data, and commands (referred to herein simply as “information”) to the onboard controller 120a and the onboard controller 120a is configured to receive the information from the onboard communications link 122a and the transient data sensors 130a. In some variations, the onboard controller 120a is configured to transmit additional information in response to or as a function of the information received from the onboard communications link 122a and/or transient data sensors 130a. For example, in some variations the onboard controller 120a transmits additional information to the transient data sensors 130a, the drive system 140, the steering system 150, the braking system 155, and/or the propulsion system 160 (e.g., via the onboard communications link 122a). And in at least one variation the onboard controller 120a transmits additional information to an external controller via the onboard communications link 122a.

The transient data sensors 130a of the MVS 100a can be proximity sensors, visual sensors, fluid level sensors, energy level sensors, electrical connection sensors, among others, that provide transient data to the onboard controller 120a. Non-limiting examples of transient data provided by the transient data sensors 130a include data on or related to MVS 100a location, MVS 100a position, MVS 100a movement, obstacle detection along a path the MVS 100a is moving along, general environmental conditions around the MVS 100a, fluid level in a container assembled onto the MVS 100a, pressure level in a container assembled onto the MVS 100a, charge level of an electric battery of the MVS 100a, resistance of a connection between two electrical components assembled onto the MVS 100a, operation of a component assemble onto the MVS 100a, among others. Accordingly, the transient data sensors 130a provide notification on how a given MVS 100a is performing operational activities such as alignment on an assembly path, tracking of a given MVS 100a along the assembly path, and obstacle avoidance on the assembly path as the MVS 100a moves within a vehicle assembly facility. In addition, the transient data sensors 130a can provide assembly information of a top hat being assembled onto the MVS 100a as the MVS 100a moves through one or more assembly zones.

The onboard controller 120a is configured to direct the propulsion system 160 to provide power to the drive system 140 and direct the drive system 140 to drive at least one of the wheels 142 such that the MVS 100a moves across a surface (e.g., a floor or road). As used herein, the term ‘drive” refers to rotating an object (e.g., a wheel) by applying a force causing the object to rotate. Accordingly, the propulsion system 160 is configured to provide power to the drive system 140 and the drive system 140 is configured to rotate the wheels 142.

In some variations, the propulsion system 160 is an electric propulsion system with one or more electric batteries that provide electric power to the drive system 140. In other variations, the propulsion system 160 is a hybrid propulsion system with one or more electric batteries and an internal combustion engine (ICE) that provides a combination of electric power and mechanical power (converted from chemical energy) to the drive system 140. In at least one variation the MVS 100a includes a hybrid propulsion system that uses electric power to move through one or more assembly zones.

The onboard controller 120a is also configured to direct the steering system 150 to steer at least one of the wheels 142 (e.g., the front two wheels 142) such that the MVS 100a follows or moves along a desired pathway. As used herein, the term “steer” or “steering” refers to guiding or controlling directional movement of a vehicle by turning at least one wheel of the vehicle. Accordingly, the steering system 150 is configured to change a course or direction of the MVS 100a. As used herein the phrase “course of direction” refers to a direction or path along which the MVS 100a is moving.

In at least one variation the onboard controller 120a is configured to direct the braking system 155 to apply a braking force such that the wheels 142 are inhibited from turning or rotating. And in some variations the onboard controller 120a is configured to direct the braking system 155 to apply an emergency braking force such that the MVS 100a and/or other MVSs 100a stop moving when an obstacle is detected approaching a predefined pathway the MVS 100a is moving along.

Referring to FIG. 4, remote control movement of the MVS 100a through a plurality of assembly zones 210, 220 is shown. Particularly, a system 10 for remote control of the MVS 100a includes a central management system 170 with a plurality of stored predetermined paths 172 and specifications 174 for the MVS 100a. That is, the central management system 170 is configured to direct the MVS 100a to move along a predetermined assembly path ‘AP’ (also referred to herein simply as “assembly path AP”) within a vehicle assembly facility via remote control.

The system 10 also includes a zone management system 180 with a plurality of zone controllers 181, 182 for the plurality of assembly zones 210, 220, respectively. The plurality of zone controllers 181, 182 are in communication with the central management system 170 and in communication with the onboard controller 120 of the MVS 100. That is, as the MVS 100a moves through assembly zone 210 shown in FIG. 4, the zone controller 181 is in communication with the onboard controller 120a via the onboard communication link 122a and a zone controller communication link 181b, and as the MVS 100 moves through zone 220 the zone controller 183 is in communication with the onboard controller 120a via the onboard communication link 122a and a zone controller communication link 182b.

In some variations the zone controller communication links 181b, 182b are wireless communication links 181b, 182b. Also, and as shown in FIG. 4, in some variations the plurality of communication links include a primary link ‘PL’ and a secondary link ‘SL’. In at least one variation, the primary link is between an MVS 100a and an active zone controller (e.g., a zone controller for a zone where an MVS is presently located) and the secondary link ‘SL’ is between an MVS 100a and an adjacent zone controller (e.g., a zone controller for a zone where the MVS will enter).

In at least one variation, the plurality of zone controllers 181, 182, and other zone controllers disclosed herein, have a manual interface system 181a, 182a, (e.g., a desktop or laptop computer) configured for entering and/or retrieving data from the plurality of zone controllers 181, 182. In at least one variation, one or more of the manual interface systems 181a, 182a is configured to provide data and/or notification to the central management system 170 regarding conditions of the assembly path AP. Non-limiting examples of such conditions include material shortages, operational problems, emergency problems within the vehicle assembly facility, among others.

The one or more of the zone controller communications link 181b, 182b are configured to receive and/or transmit data from and/or to the onboard controllers 120a of MVSs 100a such that movement of MVSs 100a throughout the plurality of zones within the vehicle assembly facility is managed and controlled. For example, in some variations the plurality of zone controllers 181, 182 are configured to receive transient data from the onboard controllers 120a of the MVSs 100a and manage movement and assembly of the MVSs 100a throughout a plurality of zones within a vehicle assembly facility.

It should be understood that the MVS 100a is directed along the assembly path AP by the central management system 170 and/or zone controllers 181, 182. Stated differently, the MVS 100a moves along the assembly path AP and through the assembly zones 210, 220 via remote control. For example, the onboard controller 120b receives transient data from one or more of the transient data sensors 130a and transmits onboard data to the onboard communications link 122a. As used herein, the phrase “onboard data” refers to data obtained or derived from the transient data sensors 130a. The onboard communications link 122a receives the onboard data from the onboard controller 120a and transmits the onboard data to an external controller (e.g., zone controller 181 and/or central management system, 170). In response to receiving the onboard data, the external controller transmits and the onboard communications link 122a receives offboard data and transmits the offboard data to the onboard controller 120a. As used herein the phrase “offboard data” refers to data transmitted to an onboard communications link from an external controller and non-limiting examples of offboard data include steering instructions, braking instructions, propulsion instructions, among others. The onboard controller 120a receives the offboard data and directs the drive system 140, steering system 150, braking system 155, and/or propulsion system 160 such that the MVS 100a desirably moves along the assembly path AP through the plurality of assembly zones 210, 220.

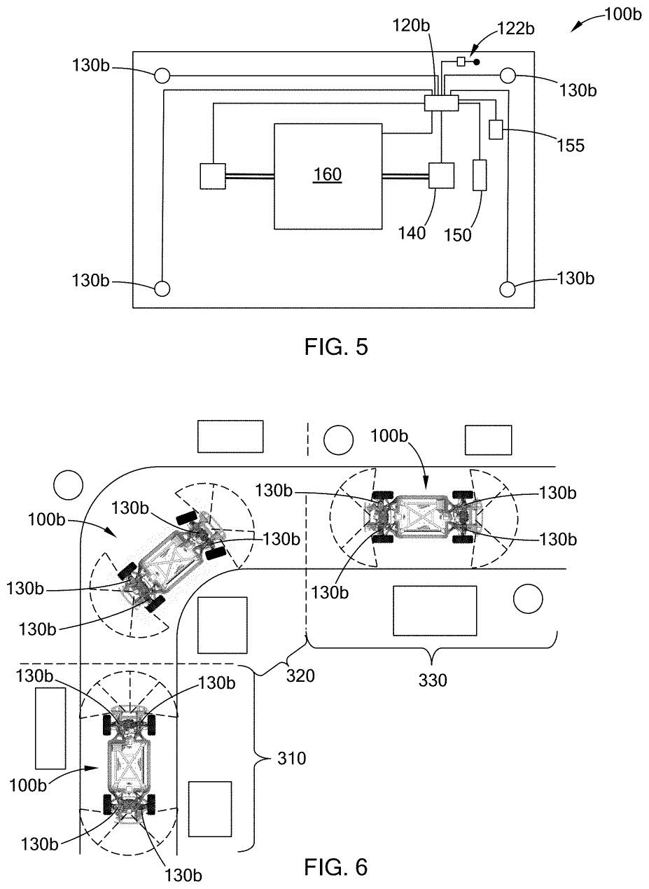

In another form of the present disclosure, an MVS 100 directs itself along the assembly path AP. For example, and with reference to FIG. 5, a functional block diagram of a MVS 100b configured for autonomous movement is shown. As used herein the terms “autonomous movement” and “autonomously” refer to movement of a MVS that is controlled or directed by an onboard controller of the MVS absent controls or commands from an external or offboard controller.

The MVS 100b includes an onboard controller 120b, transient data sensors 130b, the drive system 140, the steering system 150, the braking system 155, and the propulsion system 160. The onboard controller 120b is in communication with the transient data sensors 130b, drive system 140, steering system 150, braking system 155, and propulsion system 160. In some variations the MVS 100b includes an onboard communications link 122b and the onboard communications link 122b may or may not be in communication with the transient data sensors 130b, drive system 140, steering system 150, braking system 155, and/or propulsion system 160.

The transient data sensors 130b are configured to transmit information to the onboard controller 120b and the onboard controller 120b is configured to receive the information. In some variations, the onboard controller 120b is configured to transmit additional information in response to or as a function of the information received from the transient data sensors 130b. The transient data sensors 130b include at least one of visual sensors and proximity sensors configured to detect at least one of an assembly path, markers, and beacons, and transmit visual and/or proximity data on the assembly path, markers and/or beacons to the onboard controller 120b. And the onboard controller 120b is configured to receive the visual and/or proximity data and direct the propulsion system 160, braking system 155, steering system 150 and drive system 140 such that the MVS 100b autonomously moves along an assembly path and through one or more assembly lines of a vehicle assembly facility (e.g., a top hat assembly facility). In addition, and while the onboard controller 120b is configured to direct and move the MVS 100b autonomously, in some variations the onboard controller 120b is configured to transmit information to an external controller, e.g., via the onboard communications link 122b.

Referring to FIG. 6, autonomous movement of the MVS 100b along an assembly path AP and through a plurality of assembly zones 310, 320, 330 is shown. And in contrast to a central management system and/or zone controller(s) directing the MVS 100b along the assembly path AP, the onboard controller 120b via input from the transient data sensors 130b directs the MVS 100b along the assembly path AP. It should be understood that as the MVS 100b moves through the assembly zones 310, 320, 330, parts or components (e.g., top hat parts) are assembled onto the MVS 100b. And while the transient data sensors 130b include at least one of visual sensors and proximity sensors as noted above, it should be understood that the transient data sensors 130b can include one or more sensors that provide transient data such as data on the status of systems of the MVSs 100b, current assembly state of the MVSs 100b, proper positioning of parts on the MVSs 100b, among others. Non-limiting examples of the status of systems of the MVSs 100b include battery charge level of the MVSs 100b, tire pressure of the tires of the MVSs 100b, fluid levels of the MVSs 100b, fluid pressures in the MVSs 100b, among others. In addition, in some variations the onboard controller 120b transmits such data to an offboard controller or management system (not shown) such that monitoring of a top hat being assembled on a MVS 100b is monitored. In the alternative, or in addition to, such data is stored in one or more memory devices on the MVS 100b and transferred or downloaded to an external device after the top hat is assembled on the MVS 100b.

It should be understood from the teachings of the present disclosure that a MVS configured for remote control movement and/or autonomous movement through a plurality of assembly zone along an assembly line is provide. The MVS moves under its own power and the use and/or need for conveyors and/or automatic guided vehicles for movement of the MVS is reduced. Accordingly, the cost and complexity of assembling a vehicle top hat onto the MVS is reduced. In addition, remote control and/or autonomous movement of a plurality MVSs allows for different assembly routes to be assigned to and followed by each of the MVSs such that assembly of different top hat configurations or models on the plurality of MVSs within a single top hat manufacturing facility can be performed with a reduction of specialized and/or additional equipment.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A modular vehicle subassembly comprising:
a frame assembly comprising a vehicle frame, wheels mounted on the vehicle frame, and a steering system configured to steer at least one of the wheels and change a course of direction of the frame assembly;
a propulsion system coupled to the frame assembly and configured to drive at least one of the wheels and move the frame assembly in at least one of a forward direction and a backward direction;
at least one transient data sensor coupled to the frame assembly and configured to detect and transmit transient data; and
at least one of an onboard controller and an onboard communications link coupled to the frame assembly, wherein the onboard controller is configured to receive the transient data from the at least one transient data sensor, direct the steering system, and direct the propulsion system such that the frame assembly moves along a predefined path through a flexible modular platform facility.

2. The modular vehicle subassembly according to claim 1, wherein the wheels comprise two front wheels and two rear wheels, and the steering system is configured to steer the two front wheels.

3. The modular vehicle subassembly according to claim 1, wherein the propulsion system comprises an electric power propulsion system with at least one electric battery, at least one electric motor, and a drivetrain.

4. The modular vehicle subassembly according to claim 1, wherein the at least one transient data sensor comprises at least one of a proximity sensor, a visual sensor, a speed sensor, a fluid level sensor, and a battery charge sensor.

5. The modular vehicle subassembly according to claim 1, wherein the transient data is at least one of a status of one or more systems assembled on the frame assembly, a current assembly state of the one or more systems assembled on the frame assembly, and a position of one or more parts assembled on the frame assembly.

6. The modular vehicle subassembly according to claim 5, wherein the status of the one or more systems assembled on the frame assembly comprises at least one of a battery charge level, a tire pressure, a fluid level, and a fluid pressure.

7. The modular vehicle subassembly according to claim 1, wherein the onboard controller is coupled to the frame assembly and configured to execute at least one of a speed command, a stop movement command, a start movement command, a steer command, and an emergency stop command.

8. The modular vehicle subassembly according to claim 7, wherein the at least one transient data sensor is releasably attached to the frame assembly and configured to be releasably attached to another frame assembly.

9. The modular vehicle subassembly according to claim 8, wherein the at least one transient data sensor is configured to detect at least one of a location of the frame assembly within a flexible modular platform facility, a position of the frame assembly within the flexible modular platform facility, a movement of the frame assembly within the flexible modular platform facility, an obstacle along a path of the frame assembly within the flexible modular platform facility, and an environmental condition of the frame assembly within the flexible modular platform facility.

10. The modular vehicle subassembly according to claim 9, wherein the onboard controller is configured to direct the frame assembly to move autonomously through a flexible modular platform facility.

11. The modular vehicle subassembly according to claim 1, wherein the onboard controller and the onboard communications link are coupled to the frame assembly.

12. The modular vehicle subassembly according to claim 11, wherein:
the onboard controller is configured to receive the transient data from the at least one transient data sensor and transmit onboard data to the onboard communications link; and
the onboard communications link is configured to receive the onboard data from the onboard controller, transmit the onboard date to an external controller, receive offboard data from the external controller, and transmit the offboard data to the onboard controller.

13. The modular vehicle subassembly according to claim 12, wherein the offboard data is at least one command for the onboard controller to execute.

14. The modular vehicle subassembly according to claim 13, wherein the onboard controller is configured to direct the frame assembly to move via remote control through a flexible modular platform facility.

15. The modular vehicle subassembly according to claim 13, wherein the onboard controller is configured to direct the frame assembly to move via remote control and autonomously through a flexible modular platform facility.

16. A modular vehicle subassembly comprising:
a frame assembly comprising:
a vehicle frame;
wheels mounted to the vehicle frame;
a steering system coupled to and configured to steer at least one of the wheels and change a course of direction of the frame assembly;
a propulsion system comprising at least one electric battery, at least one electric motor, and a drivetrain, wherein the propulsion system is configured to drive at least one of the wheels and move the frame assembly in at least one of a forward direction and a backward direction; and
an onboard communications link, a plurality of transient data sensors, and an onboard controller, wherein:
the onboard communications link is configured to receive offboard data from an external controller and transmit the offboard data to the onboard controller;
the plurality of transient data sensors are coupled to the frame assembly and configured to detect and transmit transient data; and
the onboard controller is configured to receive the transient data from at least one of the plurality of transient data sensors, transmit onboard data to the onboard communications link, receive the offboard data from the onboard communications link, and direct the propulsion system and the steering system such that the frame assembly moves along a predefined path through a flexible modular platform facility.

17. The modular vehicle subassembly according to claim 16, wherein the plurality of transient data sensors comprise at least one of a proximity sensor, a visual sensor, a speed sensor, a fluid level sensor, and a battery charge sensor.

18. The modular vehicle subassembly according to claim 17, wherein the transient data is at least one of a status of one or more systems assembled on the frame assembly, a current assembly state of the one or more systems assembled on the frame assembly, and a position of one or more parts assembled on the frame assembly.

19. A modular vehicle subassembly for remote control or autonomous movement through a flexible modular platform facility, the modular vehicle subassembly comprising:
a frame assembly comprising:
a vehicle frame; and
wheels mounted to the vehicle frame;
a steering system coupled to and configured to steer at least one of the wheels and change a course of direction of the frame assembly;
a propulsion system comprising at least one electric battery, at least one electric motor, and a drivetrain, wherein the propulsion system is configured to drive at least one of the wheels and move the frame assembly in at least one of a forward direction and a backward direction; and
a plurality of transient data sensors an onboard controller, and an onboard communications link, wherein:
the onboard communications link is configured to receive offboard data from an external controller and transmit the offboard data to the onboard controller;
the plurality of transient data sensors are coupled to the frame assembly and configured to detect and transmit transient data; and
the onboard controller is configured to receive the transient data from at least one of the plurality of transient data sensors, transmit onboard data to the onboard communications link, receive the offboard data from the onboard communications link, and direct the propulsion system and the steering system such that the frame assembly moves along a predefined path through a flexible modular platform facility.

20. The modular vehicle subassembly according to claim 19, wherein the plurality of transient data sensors comprise at least one of a proximity sensor, a visual sensor, a speed sensor, a fluid level sensor, and a battery charge sensor.
